(19) United States
(12) Patent Application Publication
(10) Pub. No.: US 2011/0138713 A1
(43) Pub. Date: Jun. 16, 2011

(54) INSULATED ATTIC DOOR

(76) Inventor: Jeffery Lynn Reed, Frisco, TX (US)

(21) Appl. No.: 12/958,880

(22) Filed: Dec. 2, 2010

Related U.S. Application Data
(60) Provisional application No. 61/265,971, filed on Dec. 2, 2009.

(51) Int. Cl. E06B 7/16; E06B 3/38; E06B 1/04; E06B 1/56; E06B 5/01

(52) U.S. Cl. 52/204.1; 49/445; 52/745.15; 49/506; 49/475.1

(57) ABSTRACT

The present application relates to an attic door assembly. The attic door assembly includes a jamb having an interior surface. The jamb is installed adjacent to a pull-down attic door. The attic door assembly also includes a rabbet disposed along a perimeter of the interior surface of the jamb and a door hingedly coupled to the jamb. The door includes a frame, a panel coupled to a first side of the frame, and a foam board coupled to a second side of the frame opposite the panel. The foam board, the panel, and the frame in combination define an interior space. An insulating material is disposed within the interior space. Finally, a flexible sealant is applied to the interior surface. The flexible sealant is operable to seal an interface of the rabbet, the jamb, and the door.

### CROSS-REFERENCE TO RELATED APPLICATIONS

This application claims priority to, and incorporates by reference the entire disclosure of, U.S. Provisional Patent Application No. 61/265,971, filed Dec. 2, 2009, entitled INSULATED ATTIC DOOR.

### BACKGROUND

1. Field of the Invention

This application generally relates to attic door assemblies and more particularly, but not by way of limitation to insulated attic door assemblies capable of insulating a home against energy loss and infiltration of contaminants.

2. History of the Related Art

A home attic space is typically accessible via one of several styles of attic doors that are mounted into a ceiling in an inconspicuous area of a home. For example, one style of attic door is a pull-down door that opens inwardly into the home. This pull-down style attic door is typically hinged on one side and may be spring-assisted to facilitate closing. A folding step ladder may also be integrated with the pull-down style of door.

Another style of attic door is a panel-style attic door that opens upwardly into the attic space. The panel-style attic door typically, when in a closed position, rests on a wooden frame, is held in place by gravity, and includes no hinges or spring assistance. When an occupant of the home wants to enter the attic space, the occupant simply pushes the panel-style attic door into the attic space and moves it aside.

These two existing styles of attic doors typically require a large hole to be cut in the ceiling of the home. Once installed, an attic door typically provides a barrier of only one eighth inch plywood between an interior of the home and the attic space. Consequently, many existing attic doors provide poor insulation, which results in loss of heat or cold to the attic space. Additionally, many existing attic doors provide a poor seal between the interior of the home and the attic space, thereby allowing infiltration, for example, of dust, dirt, and other contaminants into the interior of the home.

### SUMMARY OF THE INVENTION

In one embodiment, the present application relates to an attic door assembly. The attic door assembly includes a jamb having an interior surface. The jamb is installed adjacent to a pull-down attic door. The attic door assembly also includes a rabbet disposed along a perimeter of the interior surface of the jamb and a door hingedly coupled to the jamb. The door includes a frame, a panel coupled to a first side of the frame, and a foam board coupled to a second side of the frame opposite the panel. The foam board, the panel, and the frame in combination define an interior space. An insulating material is disposed within the interior space. Finally, a flexible sealant is applied to the interior surface. The flexible sealant is operable to seal an interface of the rabbet, the jamb, and the door.

In another embodiment, the present application relates to a method of installing an attic door assembly. The method includes securing a jamb to at least two ceiling joists. The jamb is secured above a pull-down attic door and includes a rabbet disposed along a perimeter of an interior surface thereof. The method also includes hingedly connecting a door to the jamb. The door includes a frame, a panel coupled to the frame, and a foam board coupled to the frame. The foam board, the panel, and the frame define an interior space and an insulating material is disposed within the interior space. The method finally includes applying a flexible sealant to the perimeter of the interior surface adjacent to the rabbet. The flexible sealant is operable to seal an interface of the rabbet, the jamb, and the door.

In another embodiment, the present application relates to a method of manufacturing an attic door assembly. The method includes assembling a generally rectangular door jamb from at least four jamb components and assembling a generally rectangular door from at least four door frame components. The method also includes securing a panel onto a first side of the generally rectangular door, filling an interior region of the door with an insulating material, and securing a foam board onto a second side of the generally rectangular door. Finally, the method includes connecting the generally rectangular door to the generally rectangular door jamb via at least one hinge, forming a rabbet along a perimeter of an interior surface of the generally rectangular door jamb, applying a flexible sealant to the interior surface, and installing the generally rectangular door jamb adjacent to a pull-down attic door.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a schematic diagram of an insulated attic door assembly according to an exemplary embodiment;

FIG. 2A is a top view a jamb of the insulated attic door assembly of FIG. 1 according to an exemplary embodiment;

FIG. 2B is a cross-sectional view taken across line A-A of the jamb of FIG. 2A according to an exemplary embodiment;

FIG. 2C is a cross-sectional view taken across line B-B of the jamb of FIG. 2A according to an exemplary embodiment; and

FIG. 3 is a partial side view of the insulated attic door assembly of FIG. 1 according to an exemplary embodiment;

### DETAILED DESCRIPTION

Various embodiments of the present invention will now be described more fully with reference to the accompanying drawings. The invention may, however, be embodied in many different forms and should not be construed as limited to the embodiments set forth herein.

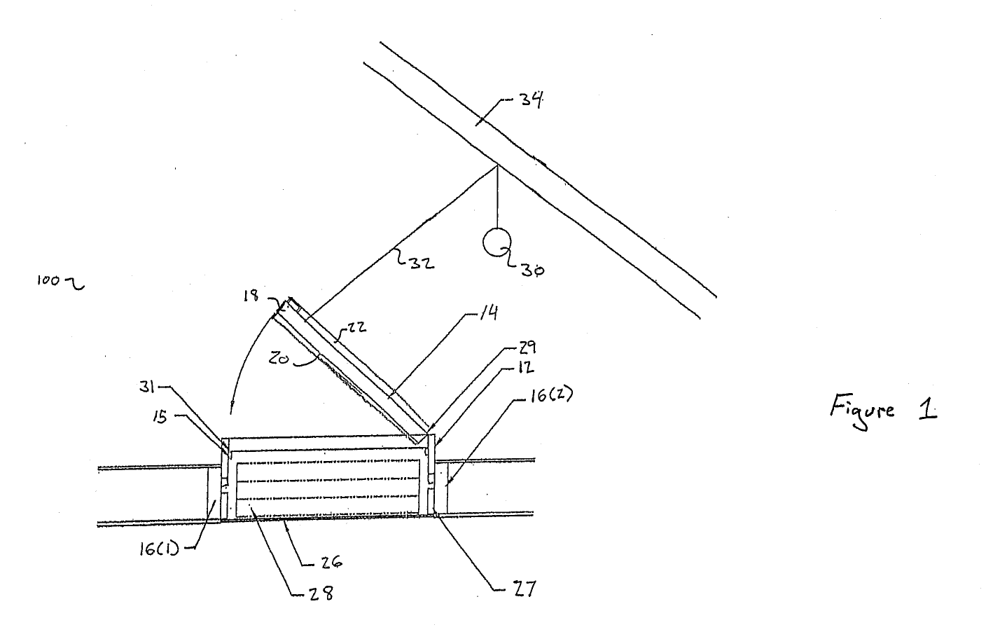

FIG. 1 is a schematic diagram of an illustrative insulated attic door assembly 100. The insulated attic door assembly 100 includes a jamb 12 and a door 14. In a typical embodiment, the door 14 includes a frame 18, a panel 20, and a foam board 22. The door 14 is connected to the jamb 12 on one side by way of a hinge 29. When closed, the door 14 rests against or closely adjacent to a rabbet 15. In a typical embodiment, the rabbet 15 is formed by affixing a plurality of rabbet components 17(1)-(4) (shown in FIGS. 2B and 2C) to an interior perimeter of the jamb 12 via glue, screws, nails, or other conventional fasteners; however, in other embodiments, the rabbet 15 is integrally formed with the jamb 12, for example, by way of routing, milling, extruding, or some other process.

In a typical embodiment, a flexible sealant 31 is applied to the interior perimeter of the jamb 12 adjacent to the rabbet 15 in order to facilitate sealing of an interface of the rabbet 15, the door 14, and the jamb 12 when the door 14 is closed. In various embodiments, the flexible sealant 31 may be, for example, adhesive foam, spring-metal strips, tubular-gasket weather-stripping, foam-filled weather-stripping, or interlocking metal weather-stripping. In a typical embodiment, the door 14 opens inwardly into an attic space. Additionally, a counterweight 30 may be connected to the door 14 by way of a cable 32 attached to the door 14 and a roof rafter 34. The counterweight 30 aids in opening and closing of the door 14.

When installed, the jamb 12 is secured between ceiling joists 16(1)-(2). As shown by way of example in FIG. 1, the insulated attic door assembly 100 may be used in conjunction with an existing pull-down door 26 having a ladder 28 attached thereto. In such an arrangement, the jamb 12 may be secured to the ceiling joists 16(1)-(2) above an existing ladder frame 27. In a typical embodiment, no modifications to the existing attic door opening or to the existing attic decking are required for installation of an insulated attic door assembly, such as is the case with the insulated attic door assembly 100.

FIGS. 2A-2C collectively show the jamb 12 in more detail. FIG. 2A is a top view, FIG. 2B is a cross-sectional view taken across line A-A, and FIG. 2C is a cross-sectional view taken across line B-B. The jamb 12 may be constructed of any appropriate material such as, for example, 1″×8″ wooden beams. The jamb 12 is sized to fit between existing ceiling joists 16(1)-(2) and occupy the same cavity created for existing pull-down style attic doors. The jamb 12 includes members 13(1)-(4). The members 13(1)-(4) are connected to each other at approximately right angles such that, when assembled, the jamb 12 has a substantially rectangular shape. Each of the members 13(1)-(4) include a rabbet component 17(1)-(4) secured to an interior face thereof. When assembled, the rabbet components 17(1)-(4) together form the rabbet 15.

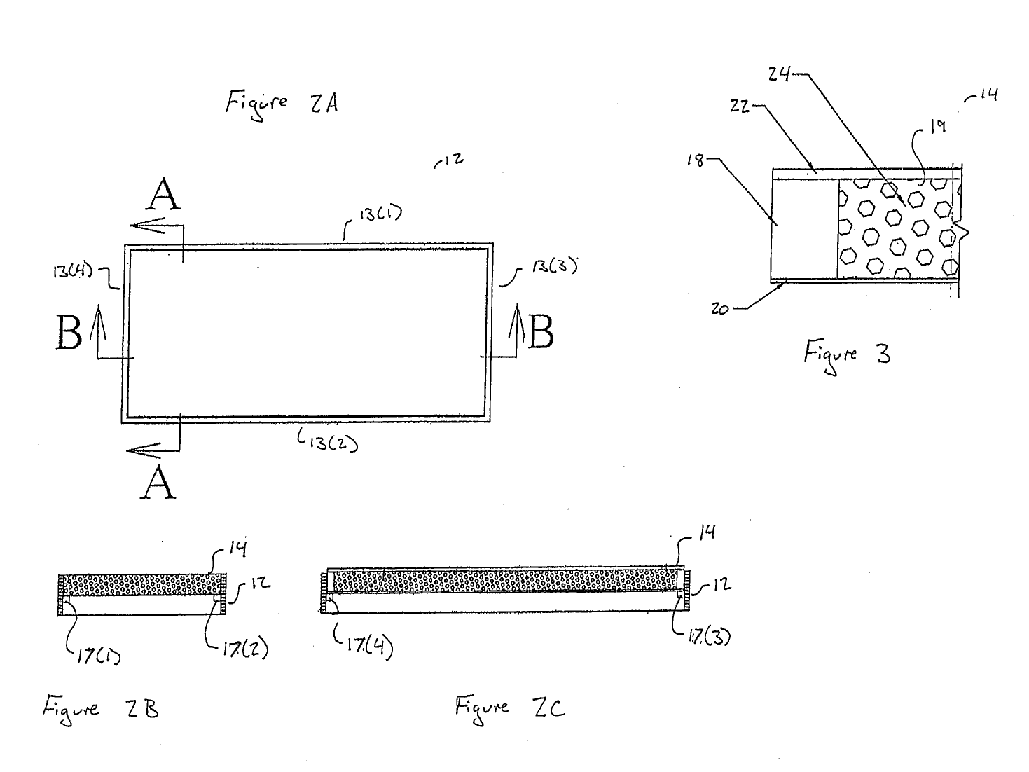

FIG. 3 is a partial side view of the door 14. In a typical embodiment, the door 14 includes a frame 18, a panel 20, a foam board 22, and insulation 24. The frame 18 may be constructed of, for example, ¾″×3″ beams secured to each other at approximate right angles such that, when assembled, the frame 18 has a substantially rectangular shape. The panel 20 is secured to an interior-facing side of the frame 18 so as to fully cover an interior space 19 of the frame 18. The insulation 24 is disposed within the frame 18. The insulation 24 fully occupies the interior space 19 of the frame 18 and has an insulation rating of approximately R13. The foam board 22 may be secured to an attic-facing side of the frame 18 similar to the panel 20. The foam board 22 has an insulation rating of approximately R3. The illustrative insulated attic door assembly 100 has a total insulation rating of approximately R16.

From the above, it may be appreciated that the illustrated embodiment provides an improved way to insulate a door between an interior of a home and an attic space. An embodiment is illustrated herein by example, and numerous modifications and rearrangements may be made by a person of ordinary skill in the art. For example, while the illustrated embodiment is described as having a foam board 22 attached to the door 14, one skilled in the art would recognize that another embodiment could omit the foam board 22. It is intended that the specification and examples be considered as illustrative only.

What is claimed is:

1. An attic door assembly comprising:
a jamb having an interior surface, the jamb operable to be installed adjacent to a pull-down attic door;
a rabbet disposed along a perimeter of the interior surface;
a door hingedly coupled to the jamb, the door comprising:
a frame;
a panel coupled to a first side of the frame;
a foam board coupled to a second side of the frame opposite the panel,
wherein the foam board, the panel, and the frame in combination define an interior space; and
an insulating material disposed within the interior space; and
a flexible sealant applied to the interior surface, the flexible sealant operable to seal an interface of the rabbet, the jamb, and the door.

2. The attic door assembly of claim 1, comprising a counterweight assembly operatively coupled to the door.

3. The attic door assembly of claim 1, wherein the jamb is secured between at least two ceiling joists.

4. The attic door assembly of claim 1, wherein the insulation has an insulation rating of R13.

5. The attic door assembly of claim 1, wherein the foam panel has an insulation rating of R3.

6. The attic door assembly of claim 1, wherein the jamb comprises at least four 1″×8″ wooden beams secured to each other at substantially right angles.

7. The attic door assembly of claim 1, wherein the frame comprises at least four ¾″×3″ wooden beams secured to each other at substantially right angles.

8. A method of installing an attic door assembly, the method comprising:
securing a jamb to at least two ceiling joists, the jamb having a rabbet disposed along a perimeter of an interior surface thereof, the jamb being secured above a pull-down attic door;
hingedly connecting a door to the jamb, the door comprising a frame, a panel coupled to the frame, and a foam board coupled to the frame;
wherein the foam board, the panel, and the frame define an interior space and an insulating material is disposed within the interior space; and
applying a flexible sealant to the perimeter of the interior surface adjacent to the rabbet, the flexible sealant operable to seal an interface of the rabbet, the jamb, and the door.

9. The method of claim 8, comprising securing a counterweight assembly to the door.

10. The method of claim 8, wherein the steps are performed in the order listed.

11. A method of manufacturing an attic door assembly, the method comprising:
assembling a generally rectangular door jamb from at least four jamb components;
assembling a generally rectangular door from at least four door frame components;
securing a panel onto a first side of the generally rectangular door;
filling an interior region of the door with an insulating material;
securing a foam board onto a second side of the generally rectangular door;
connecting the generally rectangular door to the generally rectangular door jamb via at least one hinge;
forming a rabbet along a perimeter of an interior surface of the generally rectangular door jamb;
applying a flexible sealant to the interior surface, the flexible sealant being operable to seal an interface between the rabbet, the jamb, and the door; and
installing the generally rectangular door jamb adjacent to a pull-down attic door.

12. The method of claim 11, comprising securing a counterweight assembly to the door.

13. The method of claim 11, wherein the jamb components comprise 1″×8″ wooden beams.

14. The method of claim 11, wherein the door frame components comprise ¾″×3″ wooden beams.

15. The method of claim 11, wherein the forming comprises affixing a plurality of rabbet components to the interior surface.

16. The method of claim 11, wherein the forming comprises shaping the jamb via a cutting process.

17. The method of claim 16, wherein the cutting process includes at least one of routing, milling, or extruding.

18. The method of claim 11, wherein the steps are performed in the order listed.
